(19) United States
(12) Patent Application Publication
(10) Pub. No.: US 2016/0105206 A1
(43) Pub. Date: Apr. 14, 2016

(54) Electronic Device and Method for Manufacturing Housing Thereof

(71) Applicant: Lenovo (Beijing) Co., Ltd., Beijing (CN)

(72) Inventors: Chenghao Zhang, Beijing (CN); Beiou Luan, Beijing (CN)

(73) Assignee: LENOVO (BEIJING) CO., LTD., Beijing (CN)

(21) Appl. No.: 14/673,152

(22) Filed: Mar. 30, 2015

(30) Foreign Application Priority Data
Oct. 13, 2014 (CN) 201410539075.7

(51) Int. Cl. H04B 1/3888; B21D 37/18; B21D 26/055; B21D 37/16; B21D 26/031; B21D 26/027

(52) U.S. Cl. CPC H04B 1/3888; B21D 26/031; B21D 26/027; B21D 26/055; B21D 37/16; B21D 37/18

(57) ABSTRACT

An electronic device and a method for manufacturing the housing thereof are disclosed. The electronic device includes a housing made of a metal material, the housing has a bottom, a sidewall extending along a first direction from an outer edge of the bottom, and a texture extending from an outer surface of the bottom to an outer surface of the side wall; M electronic elements set in the housing fixedly, where M≧1 and is a positive integer. The texture of the surface of the housing of the electronic device provided by the disclosure is extended from the bottom to the side wall, providing the user with a favorite appearance effect.

This application claims priority to Chinese Patent Application No. 201410539075.7 filed on Oct. 13, 2014, the entire contents of which are incorporated herein by reference.

The disclosure is related to the field of electronic technology, and particularly to an electronic device and a method for manufacturing a housing thereof.

### BACKGROUND

As the electronic technology is developing and the application requirement is improving, some textures will be made on the surfaces of the housings of the electronic devices, such as a smart phone, a tablet computer, a television set, etc., such that the texture feeling, the touch feeling, and the vision of those electronic devices can achieve certain effect, thus the use experience of the user is improved.

In the related art, the method for manufacturing the housing with a texture surface of the electronic device generally is: manufacturing a concave and convex texture on a planar sheet by employing a method for transferring, silk-screen printing, and the like firstly, and then bending the planar sheet with the concave and convex texture into the housing of the electronic device; however, the concave and convex texture at the bend portion is prone to cause an extrusion damage upon the deformation, such that the existing concave and convex texture on the planar sheet will be damaged in the machining procedure during which the housing of the electronic device is manufactured. Alternatively, the entire housing of the electronic device is manufactured from the planar sheet firstly, and then a first portion of the texture pattern is formed on the bottom side of the housing and a second portion of the texture pattern is formed on the sidewall of the housing by employing the methods for transferring, silk-screen printing, and the like. The effect of the housing manufactured by such manufacturing process is: the first portion of the texture pattern on the bottom side of the housing is separated from the second portion of the texture pattern on the sidewall of the housing and all of them are incomplete; it is difficult for the user to consider the a pattern constituted by those two portions of the texture patterns as the same one pattern, since the first portion of the texture pattern on the bottom side and the second portion of the texture pattern on the sidewall are not continuous. In other words, the first portion of the texture pattern on the bottom side of the housing may be considered as a first texture effect, and the second portion of the texture pattern on the sidewall of the housing may be considered as a second texture effect, thus the first and the second texture effects are two texture effects different from each other thoroughly. Such manufacturing process procedure is not only complicated but also costly, and the yield is low, thus the requirement for the product engineering will never be achieved at all.

### SUMMARY

In a first aspect, in the disclosure, it is provided an electronic device comprising: a housing made of a metal material, the housing comprising a bottom, a sidewall extending along a first direction from an outer edge of the bottom, and a texture extending from an outer surface of the bottom to an outer surface of the side wall; M electronic elements set in the housing fixedly, where M≧1 and is a positive integer.

In a second aspect, it is provided a method for manufacturing a housing of an electronic device, the method comprising: placing a metal sheet in a solid state into a mold comprising a cavity having a texture structure; heating the metal sheet and converting the metal sheet from the solid state to a superplastic state; injecting a gas into the mold to make the metal sheet in the superplastic state gas-bulging and attach to the texture structure of the cavity; cooling the metal sheet and converting the metal sheet from the superplastic state to the solid state to form the housing comprising an outer surface having a texture corresponding to the texture structure.

### BRIEF DESCRIPTION OF THE DRAWINGS

A further illustration for the disclosure is made in conjunction with the drawing.

FIG. 1 is a schematic diagram of a structure of a housing of the electronic device provided in an embodiment of the disclosure.

FIG. 2 is a schematic diagram of a form in which a metal sheet is placed in a mold provided by the embodiment of the disclosure.

FIG. 3 is a schematic diagram of another form in which the metal sheet is placed in the mold provided by the embodiment of the disclosure.

FIG. 4 is a flowchart of a method for manufacturing the housing of the electronic device provided by the embodiment of the disclosure.

### DETAILED DESCRIPTION

For a further explanation of the technical means employed by the disclosure and the effect thereof, the electronic device and the method for manufacturing the housing thereof presented in accordance with the disclosure and the particular implementation, the structure, the feature, and the effect thereof are described in detail in conjunction with the drawings and the embodiments as below.

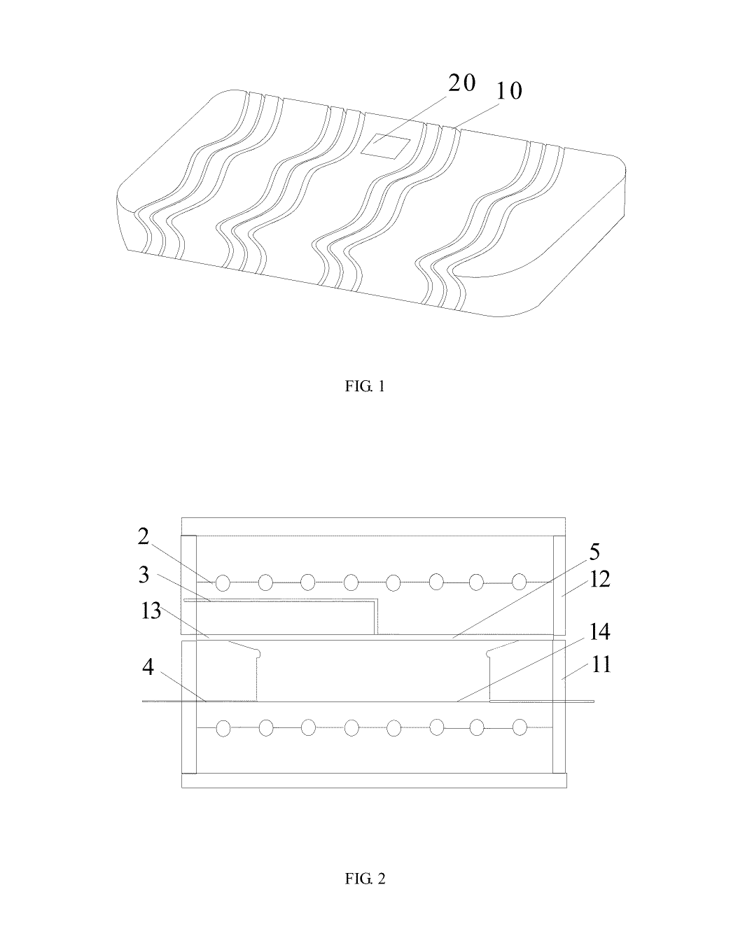

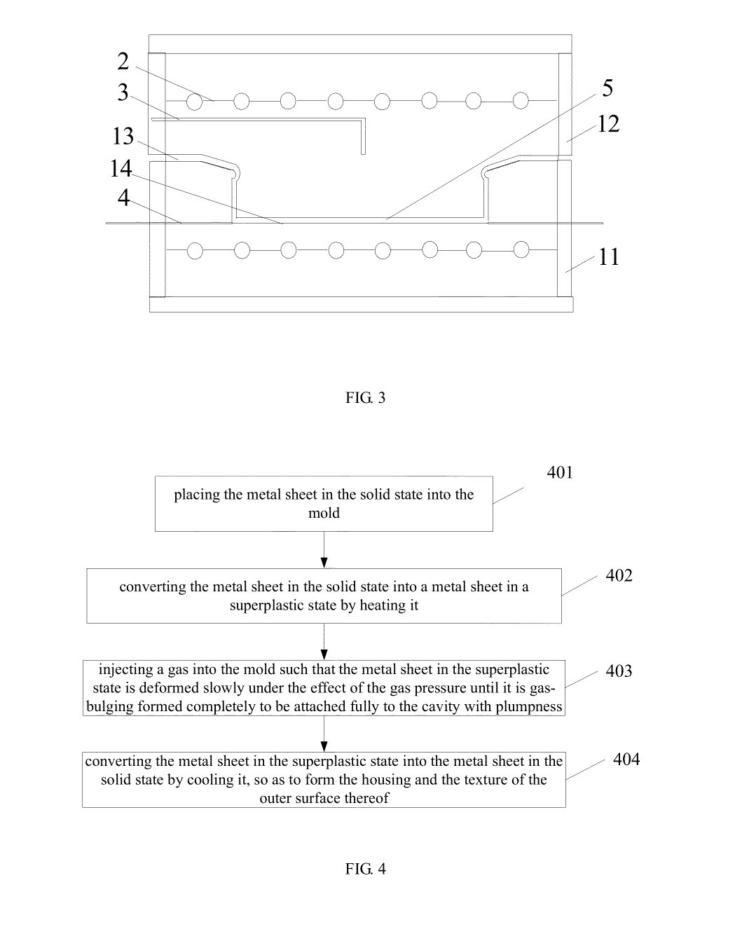

The structure diagram of the electronic device provided by the embodiment of the disclosure is shown in FIG. 1. In particular, as shown in FIG. 1, the electronic device provided by the present embodiment comprises: a housing 10 made of a metal material and M electronic elements 20.

The housing 10 has an accommodation space, and comprises a bottom and a sidewall formed by an extension in a first direction from an outer edge of the bottom, and the bottom and the sidewall constitute the accommodation space together. The outer surface of the housing 10 has a texture, and the outer surface of the bottom of the housing 10 and the outer surface of the sidewall of the housing 10 constitute the outer surface of the housing; the texture is extended from the outer surface of the bottom to the outer surface of the sidewall, such that the texture patterns constituted on the outer surfaces of the bottom and the sidewall of the housing are the same texture pattern, i.e., a continuous texture pattern is formed on the outer surfaces of the bottom and the sidewall. Wherein the texture is a texture with a three-dimension effect, as shown in FIG. 1. Of course, the depth and the grain size of the texture may be accurate in a predetermined extent with respect to the requirement for the appearance vision of different products, for example, the texture may be a nanometer level texture.

M electronic elements 20 are set in the housing fixedly, and M is a positive integer. The element may be a battery, a circuit board, a display screen, and various chips on the circuit board, and so on.

Further, in order that the texture is able to be extended from the outer surface of the bottom of the housing to the outer surface of the sidewall to form the continuous texture, it is necessary that the texture is formed on the outer surface of the housing at the same time when the housing is formed, and the yield is possible to be improved, which is suitable for practice use. In particular, the housing and the texture located on the outer surface thereof may be manufactured together by a predetermined process, satisfying the requirement for the product engineering.

Further, in the embodiment above, the housing and the texture located on the outer surface thereof may be manufactured together by the predetermined process, and the embodiment of the disclosure may employ the following predetermined processes but is not limited thereto.

(1) A planar sheet into a housing of the electronic device is bended firstly, and then a concave and convex texture on the housing is manufactured by employing a method of laser carving, etching, and the like. However, for the housing with a three-dimensional structure, the texture pattern obtained by employing such process results in an awful vision effect at the connection portion between the bottom and the sidewall of the housing, and it is comparatively difficult to obtain the continuous texture pattern thereat.

(2) A concave and convex texture on the planar sheet is manufactured by employing a method of transferring, silk-screen printing, and so on firstly, and then the planar sheet with the concave and convex texture is bended into the housing of the electronic device; however, the concave and convex texture at the bend is prone to cause an extrusion damage upon the deformation, such that the existing concave and convex texture on the planar sheet will be damaged in the procedure of the machining of the housing of the electronic device, thus the damage ratio is high, and the yield is low.

(3) The metal sheet in a superplastic state placed in a mold is gas-bulging formed through a gas into a cavity in the mold firstly, so as to form the housing with the texture. There is a cavity in the mold, and both of the bottom and the side surface connected therewith in the cavity in the mold have a structure in which a continuous texture is formed on the housing in the procedure of the molding of the housing, and the structure of the texture may be an intaglio (groove), and may also be a carve (protrusion), and the size of the cavity matches that of the accommodation space of the housing.

Then, placing the metal sheet in the solid state into the mold. The cavity is included in the mold, and both of the bottom and the side surface connected therewith in the cavity have a structure in which a continuous texture is formed on the outer surfaces of the bottom and the sidewall of the housing in the procedure of the molding of the housing. The particular implementation for the structure of the continuous texture may employ, but is not limited to, the following manners:

(1) A pattern of the texture formed on the outer surface of the housing is transferred into an inner surface of the cavity of the mold through a metal etching process by means of film exposure and development, and then the inner surface of the cavity of the mold is etched by an etching liquid to obtain a structure corresponding to the pattern, the inner surface of the cavity comprising the bottom and the side surface of the cavity; the structure of the inner surface of the cavity is configured for the texture formed on the outer surface of the housing; the structure of the inner surface of the cavity is located successively on the bottom and the side surface of the cavity.

(2) The inner surface of the cavity of the mold is ablated point by point through a laser in accordance with the pattern for the texture formed on the outer surface of the housing, and a structure corresponding to the pattern is formed on the inner surface of the cavity of the mold; the inner surface of the cavity comprises the bottom and the side surface of the cavity; the structure of the inner surface of the cavity is configured for the texture formed on the outer surface of the housing; the texture structure of the inner surface of the cavity is located successively on the bottom and the side surface of the cavity.

The metal sheet in the solid state is converted into the metal sheet in the superplastic state by heating it finally; a gas is injected into the mold, and the metal sheet in the superplastic state is deformed slowly under the effect of the gas pressure until it is gas-bulging formed completely to be attached fully to the cavity with plumpness; converting the metal sheet in the superplastic state into a solid state by cooling it to form the housing and the texture of the outer surface thereof.

In summary, it is possible that the texture at the connection portion between the bottom and the sidewall of the housing may be made continuous by employing the third predetermined process, such that the manufacturing of the housing and the surface texture thereof is achieved, not only is the favorite appearance effect obtained, but also the process procedure is simple and inexpensive. The consumed time is shorter and the yield is higher as compared with the first and the second predetermined processes, satisfying the requirement for the product engineering.

In the embodiment in accordance with the disclosure, it is provided a method for manufacturing a housing, as shown in FIG. 3, which is applied to an electronic device comprising at least M elements; where M≧1 and is a positive integer, and the method comprises: 401: placing the metal sheet in the solid state into the mold.

Wherein the cavity is included in the mold, and both of the bottom and the side surface connected therewith in the cavity have the structure for forming the continuous texture on the outer surfaces of the bottom and the sidewall of the housing in the procedure of molding of the housing.

In the present embodiment, two sub-molds may be employed to constitute the mold. The mold comprises a first and a second sub-molds 11 and 12, as shown in FIG. 2. The cavity is surrounded by the first and the second sub-molds 11 and 12, and both of the bottom and the side surface connected therewith in the cavity have the structure of the continuous texture extending from the bottom to the side surface connected therewith in the cavity. Accordingly, the step 301 may be implemented by employing the following steps particularly: placing the metal sheet 5 in a solid state into the first sub-mold 11 firstly, And fastening the second sub-mold 12 onto the first sub-mold 11 then.

In the present embodiment, before placing the metal sheet in the solid state into the first sub-mold, it is required to choose the shape of the cavity of the mold for manufacturing the housing of the electronic device, and the shape of the cavity is adapted to that of the housing of the electronic device to be manufactured; the particular shape of the cavity is not designated particularly herein, and depends on the shape of the housing of the electronic device to be manufactured upon the particular implementation, for example, the housing of the electronic device may have a sharp coffin corner, a chamfer, an undercut structure, and the like. However, the style of the surface texture in the cavity may be a stripe, a grid, an image, and a text logo, etc.

It is to be supplemented herein that the implementation of the texture pattern on the cavity of the first sub-mold may be implemented by employing two manners as follows, in particular:

(1) Etching the texture. The particular implementation flow is: choosing certain texture pattern from the drawing archive of the texture and outputting a negative film of the texture pattern, acquiring a negative film of a soft and thin model in accordance with the negative film of the texture pattern, spraying a photogelatin on a contact surface contacting with the metal sheet to be manufactured of the mold, placing the negative film of the soft and thin model on the photogelatin, implanting the texture pattern onto the mold by the transferring technology after an exposure and a development, and presenting the texture pattern on the mold surface by a chemical etching.

(2) Ablating the texture by a laser. The particular implementation flow is: inputting a template of the drawing archive of the texture, placing the template of the drawing archive of the texture on the inner surface of the cavity of the mold, and machining and carving the inner surface of the cavity by the laser then, wherein the diameter of the laser beam may be 4, 0.04 mm or 4, 0.1 mm, such that the metal sheet to be manufactured is vaporized under an ultra-high power intensity by the laser, and carved into a texture compliant with the template of the drawing archive of the texture finally. Wherein the depth of the texture of the metal sheet to be manufactured may be controlled accurately by the laser beam in accordance with the difference of the quality of the required surface machining, and the accuracy may be 0.01˜0.02 mm.

Of course, the implementation of the texture pattern in the cavity of the mold is not only limited to the two manners as described above, and is not designated particularly in the disclosure.

In practice operation, the design of the surface texture in the cavity of the mold generally is: the minimum depth of the surface texture may be 0.03 mm; the relationship between the pitch B and the depth H of the lines of the surface texture satisfies: H=B/10; and the relationship between the width C and the depth H of the lines of the surface texture satisfies: H=C/5.

402. The metal sheet in the solid state is converted into the metal sheet in the superplastic state by heating it.

Wherein the particular implementation of converting the metal sheet in the solid state into the metal sheet in the superplastic state by heating may be: heating the metal sheet in the solid state through a heating pipe on the mold. In the present embodiment, as shown in FIGS. 2 and 3, a heating pipe 2 is set on the mold, and the heating pipe 2 may be set on the first sub-mold 11 when the mold comprises the first and the second sub-molds 11 and 12; alternatively, the heating pipe 2 may be set on the second sub-mold 12; alternatively, the heating pipes 2 may be set on each of the first and the second sub-molds 11 and 12. If the heating pipes 2 are set on each of the first and the second sub-molds 11 and 12, the first sub-mold 11 is maintained within the temperature range for the deformation of the metal sheet under the effect of the heating pipe 2, and after the second sub-mold 12 is fastened onto the first sub-mold 11, the metal sheet 5 in the solid state is heated, such that the temperature of such sheet is compliant with that of the first sub-mold 11, thereby the metal sheet in the solid state is converted into the metal sheet in the superplastic state. The procedure of the heating of the metal sheet in the solid state is a slow procedure of heating upon the practice use. The temperature and duration for heating may be set in accordance with the physical properties of the deformation by heating for the metal sheet upon the particular embodiment, and the temperature and duration for heating set for different materials may be different from each other.

403. A gas is injected into the mold, and the metal sheet in the superplastic state is deformed slowly under the effect of the gas pressure until it is completely gas-bulging formed to be attached fully to the cavity with plumpness.

In the present embodiment, after converting the metal sheet in the solid state into the metal sheet in the superplastic state by heating it, injecting the gas into the mold, and the metal sheet in the superplastic state is deformed slowly under the effect of the gas pressure until it is completely gas-bulging formed to be attached fully to the cavity with plumpness, in order to form the housing of the electronic device; meanwhile, the texture on the bottom of the cavity and the side surface connected therewith may be printed on the surface of the metal sheet in the superplastic state, such that a continuous texture structure corresponding to the texture on the bottom of the cavity and the side surface connected therewith is formed.

Upon particular implementation, after the step of injecting a gas into the mold, and the metal sheet in the superplastic state is deformed slowly under the effect of the gas pressure until it is completely gas-bulging formed to be attached fully to the cavity with plumpness, the method further comprises the steps as follows: conducting a dwelling processing on the completely gas-bulging formed metal sheet attached fully to the cavity with plumpness firstly, such that the completely gas-bulging formed metal sheet attached fully to cavity with plumpness is in an environment with the set pressure intensity for a preset time duration.

In the present embodiment, a successive inflation of the high pressure gas into the accommodation space will result in a breakage of the formed housing of the electronic device by the high pressure gas, therefore, after the housing of the electronic device is formed by the metal sheet, it is required to stop inflating gas into the cavity of the mold, such that the pressure in the cavity is maintained at a predetermined pressure. The purpose for maintaining the pressure of the cavity at the predetermined pressure for the preset time duration is to shape the formed housing of the electronic device. Wherein the preset time may be “3 minutes”, “30 minutes”, or “1 hour”, and the like, and the setting of the preset time may depend on the material of the different housing of the electronic devices to be manufactured upon the particular implementation, and is not limited herein.

Then, a pressure-release processing is conducted on the completely gas-bulging formed metal sheet attached fully to the cavity with plumpness when the preset time duration is elapsed.

Wherein, when the preset time duration is reached, that is, after the housing of the electronic device is shaped, in order to prevent the deformation of the shaped housing of the electronic device due to the incompliance of the pressure in the accommodation space and the surrounding when the shaped housing of the electronic device is taken out at the subsequent mold opening, therefore, the pressure-release processing is conducted on the metal sheet printed with the texture pattern before the mold opening, that is, a predetermined pressure in the accommodation space in the mold is released. Upon the particular embodiment, when the preset time duration is elapsed, as shown in FIG. 3, the high pressure gas in the cavity is exhausted by an air outlet pipe of the mold, such that the predetermined pressure in the accommodation space is released. Wherein the air outlet pipe 4 is set on the second sub-mold 11, if the mold comprises the first and the second sub-molds 11 and 12.

404. The metal sheet in the superplastic state is converted into the metal sheet in the solid state by cooling it to form the housing and the texture of the outer surface thereof.

In the present embodiment, the housing of the electronic device is cooled, such that the temperature of the housing of the electronic device is less than the deformation temperature for manufacturing the sheet of the housing of the electronic device, in order that it is convenient to take out the formed housing of the electronic device upon the subsequent mold opening. The natural cooling, winding cooling, and watering cooling may be employed to be the method for cooling the temperature of the housing of the electronic device. Upon particular implementation, a cold gas may be inhaled into the accommodation space through an air inlet pipe, and a hot gas in the accommodation space may be exhausted by opening the air outlet pipe simultaneously, such that a gas circulation is formed in the accommodation space to decrease the temperature of the formed housing of the electronic device. Alternatively, a gap may be opened on the mold in the direction of the inflation of the high pressure gas, so as to cooling the formed housing of the electronic device. Of course, the method for cooling the formed housing of the electronic device is not limited to those as described above, and any one of the methods capable of implementing the cooling effect in the related art may also be employed, and there is not any limitation in the disclosure.

It is provided an electronic device and a method for manufacturing the housing thereof in the embodiment of the disclosure, the bottom and the sidewall thereof constitute an accommodation space together, and the outer surface of the bottom and the outer surface of the sidewall constitute the outer surface of the housing; the texture is extended from the outer surface of the bottom to the outer surface of the side wall, such that the texture pattern constituted on the outer surface of the bottom and the texture pattern constituted on the outer surface of the sidewall of the housing are the same texture pattern, that is, a continuous texture pattern is formed on the outer surface of the bottom and the outer surface of the sidewall. In particular, since the structure of the housing is three-dimensional, the texture may be manufactured by employing the same predetermined process upon the formation of the housing, thereby the texture at the connection portion between the bottom and the sidewall of the housing is continuous, and not only is a more favorite appearance effect obtained, but also the yield is high, satisfying the requirement for the product engineering. In addition, the metal sheet in the solid state may be converted into the metal sheet in the superplastic state by employing a predetermined process, and the metal sheet in the superplastic state is gas-bulging formed into the cavity of the mold under the effect of the gas, so as to form the housing with the texture, such that the manufacturing of the housing and the surface texture thereof is achieved, and the process procedure is simple, inexpensive, and suitable for practice use.

Further, before placing the metal sheet in the solid state into the mold, the method may comprise: clearing the surface of the metal sheet in the solid state. The purpose of clearing is to prevent the surface texture of the formed housing of the electronic device from being incomplete due to the substance, such as dust, impurity, and the like, carried on the surface of the metal sheet to be manufactured upon the subsequent formation of the texture, and meanwhile, the flatness of the surface of the housing of the electronic device formed subsequently will also be affected.

Further, in order to prevent the mold and the housing of the electronic device from being glued together in the procedure in which the mold is opened to take out the formed housing of the electronic device after the housing of the electronic device is formed by the metal sheet subsequently, before placing the metal sheet in the solid state into the mold, the method may also comprise: coating a mold releasing agent on the surface of the metal sheet in the solid state. In the present embodiment, the phenomenon in which the housing of the electronic device is damaged due to a gluing between the mold and the housing of the electronic device when the formed housing of the electronic device is taken out from the mold may be avoided to be occurred effectively by coating the mold releasing agent.

It is to be supplemented herein that before placing the metal sheet to be manufactured into the mold, it is required to acquire the metal sheet to be manufactured with a predetermined dimension, and calculate the required size of the dimension of the metal sheet to be manufactured in accordance with the structure of the housing of the electronic device to be manufactured, so as to avoid the material waste and save the cost.

Wherein in accordance with the method for manufacturing the housing of the electronic device provided in the disclosure, the employed metal sheet adapted to manufacture the housing of the electronic device by the manufacturing method has a property of high temperature gas-bulging forming. Upon the particular implementation, the metal sheet is a metal sheet, and each of the deformation temperature, the grain size, and the deformation ratio, etc. of the metal sheet has impact on the high temperature gas-bulging formation of the metal sheet, in particular, as follows:

(1) The Impact Due to the Deformation Temperature

The deformation of the high temperature gas-bulging formation of the metal sheet is affected by the deformation temperature. Generally, the metal sheet is heated to a temperature T≧0.5Tm; however, the temperature of normal metal sheet results in the high temperature gas-bulging formation in a range of 0.4˜0.85Tm, as shown in Table 1, therefore, the temperature of the metal sheet is controlled in 0.5Tm≦T≦Tc, where Tm is the deformation temperature of the metal sheet, and Tc is the crystallization temperature of the metal corresponding to the metal sheet.

(2) Impact Due to the Grain Size

It is generally required that the diameter of the grain size of the metal corresponding to the metal sheet is around 0.5˜5 um, and the grain size higher than 10 um is generally difficult for implementing the high temperature gas-bulging formation.

(3) Impact Due to the Deformation Ratio

There is a range of deformation ratio for the deformation of the high temperature gas-bulging formation at certain temperature for each microcrystalline material with the high temperature gas-bulging formation. The range of the deformation ratio may be widened by increasing the temperature or decreasing the grain size, otherwise it is narrowed. The material never demonstrates the high temperature gas-bulging formation out of such range of the deformation ratio.

Based on the above description, the metal sheet employed by the housing of the electronic device manufactured by the method for manufacturing the housing of the electronic device provided by the disclosure may be selected from the sheet listed in Table 1, in particular, with reference to the data in Table 1:

TABLE 1
data

| | | | | deformation | |
|---|---|---|---|---|---|
| | grain | high temperature | deformation | temperature | value |
| Model NO. | size(μm) | gas-bulging formation | ratio (s⁻¹) | (° C.) | of m |
| Titanium | <10, | 750~1170 | 1.3 × 10⁻⁴~10⁻³ | 900~980 | 0.75 |
| alloy TC4 | better, | | | | |
| | <7 | | | | |
| Titanium | <10 | 420 | 2 × 10⁻⁴ | 1000 | 0.49 |
| alloy TC15 | | | | | |
| KS7475 | 10 um | 500% | 6 × 10⁻⁴/s | 515 | 0.8 |
| steel SP2004 | 10 um | 300% | 2 × 10⁻³/s | 450 | 0.5 |
| steel SP220 | 10 um | | 3 × 10⁻³/s | 480 | 0.5 |
| steel SP5083 | 10 um | | 1 × 10⁻³/s | 500 | 0.35 |
| steel SP7475 | 10 um | 600% | 2 × 10⁻⁴/s | 515 | 0.7 |
| Lital8090 | 10 um | | 1 × 10⁻³/s | 530 | 0.45 |
| steel SP2090 | 10 um | | 1 × 10⁻³/s | 520 | 0.55 |
| aluminium | 12 um | 500% | 1.5 × 10⁻⁴/s | 516 | 0.7 |
| pipe 7475 | | | | | |
| aluminium | 9 um | 400% | 8.3 × 10⁻⁴/s | 510 | |
| pipe 7475 | | | | | |
| aluminium | 32 um | 200% | 8.33 × 10⁻³/s | 500 | 0.24 |
| AA5182 | | | | | |
| aluminium | 8.2 um | 500% | 1 × 10⁻³/s | 530 | 0.58 |
| AA5083 | | | | | |
| aluminium | | 246% | 6.56 × 10⁻⁵/s | 535 | 0.4 |
| AA5083 | | | | | |
| magnesium | 4.5 um | 362.50% | 7 × 10⁻⁴/s | 400 | 0.38 |
| alloy AZ31 | | | | | |
| magnesium | 9.1 um | 604% | 1.51 × 10⁻³/s | 300 | 0.5 |
| alloy AZ91D | | | | | |
| magnesium | 17 um | 461% | 3 × 10⁻⁵/s | 375 | 0.4 |
| alloy AZ61 | | | | | |

The embodiment of the disclosure is not limited to the material of the metal sheet listed in Table 1, and may be other sheet of modal number, and is not limited particularly in the disclosure.

Further, the factors affecting the high temperature gas-bulging formation of the metal sheet also include the friction condition between the metal sheet and the mold surface, therefore, the friction condition between the metal sheet and the mold surface is required to be analyzed when the high temperature gas-bulging formation is conducted on the sheet of the metal housing, and then a corresponding measure is taken to reduce the friction between the metal sheet and the mold surface. Generally, a protective lubricant may be coated on the surface contacted with the metal sheet and/or the mold surface, and not only is the friction between the metal sheet and the mold surface reduced, but also an effect for preventing the metal sheet from being oxidized is achieved at certain extent. Thus, before the step 401 in the method provided by the embodiment as described above: placing the metal sheet in the solid state into the mold, the method may further comprise the following step: coating a protective lubricant on the surface of the metal sheet in the solid state and/or an inner wall of the cavity of the mold.

It is to be stated that various method embodiments are expressed to be a combination of a series of actions for a brief description, however, it is to be appreciated by those skilled in the art that the disclosure is not limited to the sequence of the described actions, and some steps may employ other sequences or be carried out simultaneously. Secondly, it is to be understood by those skilled in the art that all of the embodiments described in the specification pertain to the embodiments, and the involved actions and modules are not necessarily required by the disclosure.

Finally, it is to be stated that the above embodiments are only utilized to illustrate the technical solution of the disclosure, and are not any limitation thereto; although a detailed depiction is made on the disclosure with reference to the above embodiments, it is to be understood by those ordinary skilled that the technical solutions recorded in the various embodiments as described above may still be modified, or part of the technical features therein may be replaced equivalently; and those modifications and replacement does not cause the principle of the corresponding technical solutions to be departed from the spirit and scope of various technical solutions of the embodiment of the disclosure.

1. An electronic device, comprising:
a housing made of a metal material, the housing comprising a bottom, a sidewall extending along a first direction from an outer edge of the bottom, and a texture extending from an outer surface of the bottom to an outer surface of the side wall;
M electronic elements set in the housing fixedly, where M≧1 and is a positive integer.

2. The electronic device of claim 1, wherein the housing comprises an outer surface comprising the outer surface of the bottom and the outer surface of the side wall, and the texture is formed on the outer surface of the housing at the same time when the housing is formed.

3. The electronic device of claim 2, wherein the housing and the texture thereof are manufactured together by a predetermined process.

4. The electronic device of claim 3, wherein the housing comprises an accommodation space enclosed by the bottom and the sidewall, and the step of the housing and the texture located on the outer surface thereof are manufactured together by the predetermined process that comprises passing a metal sheet in a superplastic state placed in a mold through a gas, so as to gas-bulging form it into a cavity in the mold to form the housing with the texture; the mold has a cavity; both of a bottom and a side surface connected therewith in the cavity have a structure in which the continuous texture is formed on the housing in a procedure of the molding of the housing, and the size of the cavity matches that of the accommodation space of the housing.

5. The electronic device of claim 4, wherein the step of the housing and the texture located on the outer surface thereof are manufactured together by the predetermined process further comprises:
placing the metal sheet in the solid state into the mold; the mold comprises the cavity, and both of the bottom and the side surface connected therewith in the cavity have a structure in which the continuous textures are formed on the outer surfaces of the bottom and the sidewall of the housing in the procedure of the molding of the housing;
converting the metal sheet in the solid state into the metal sheet in a superplastic state by heating it;
injecting a gas into the mold, and the metal sheet in the superplastic state is deformed slowly under the effect of the gas pressure until it is gas-bulging formed completely to attached fully to the cavity with plumpness; and
converting the metal sheet in the superplastic state into a solid state by cooling it to form the housing and the texture of the outer surface thereof.

6. The electronic device of claim 5, wherein the step of both of the bottom and the side surface connected therewith in the cavity of the mold have the structure in which the continuous textures are formed on the outer surfaces of the bottom and the sidewall of the housing in the procedure of the molding of the housing is:
transferring a pattern for forming the texture on the outer surface of the housing into an inner surface of the cavity through a metal etching process by means of the film exposure and development, and etching an inner surface of the cavity of the mold by an etching liquid subsequently to obtain a structure corresponding to the pattern, the inner surface of the cavity comprising a bottom and a side surface of the cavity; the structure of the inner surface of the cavity is configured for the texture formed on the outer surface of the housing; the structure of the inner surface of the cavity is located successively on the bottom and the side surface of the cavity; or
ablating the inner surface of the cavity of the mold point by point in accordance with the pattern for the texture formed on the outer surface of the housing by a laser to form a structure corresponding to a pattern on the inner surface of the cavity of the mold; an inner surface of the cavity comprises a bottom and a side surface of the cavity; the structure of the inner surface of the cavity is configured for the texture formed on the outer surface of the housing; the texture structure of the inner surface of the cavity is located successively on the bottom and the side surface of the cavity.

7. The electronic device of claim 1, wherein the texture is a nanometer level texture.

8. A method for manufacturing a housing of an electronic device comprising:
placing a metal sheet in a solid state into a mold comprising a cavity having a texture structure;
heating the metal sheet and converting the metal sheet from the solid state to a superplastic state;
injecting a gas into the mold to make the metal sheet in the superplastic state gas-bulging and attach to the texture structure of the cavity;
cooling the metal sheet and converting the metal sheet from the superplastic state to the solid state to form the housing comprising an outer surface having a texture corresponding to the texture structure.

9. The method of claim 8, wherein, after the step of injecting a gas into the mold, and the metal sheet in the superplastic state is deformed slowly under the effect of the gas pressure until it is gas-bulging formed completely to attached fully to the cavity with plumpness, further comprising:
conducting a dwelling processing on the completely gas-bulging formed metal sheet attached fully to the cavity with plumpness, so as to cause it to be in an environment with a preset pressure intensity for a preset time duration; and
conducting a pressure-release processing on the completely gas-bulging formed metal sheet attached fully to the cavity with plumpness when the preset time duration is elapsed.

10. The method of claim 9, wherein, the step of conducting the pressure-release processing on the completely gas-bulging formed metal sheet attached fully to the cavity with plumpness when the preset time duration is elapsed comprises exhausting the high pressure gas in the cavity through an air outlet pipe of the mold when the preset time duration is elapsed.

11. The method of claim 8, wherein, the step of converting the metal sheet in the superplastic state into the metal sheet in the solid state by heating it is comprises heating the metal sheet in the solid state through a heating pipe on the mold.

12. The method of claim 8, wherein, before placing the metal sheet in the solid state into the mold, further comprising clearing the surface of the metal sheet in the solid state.

13. The method of claim 8, wherein, before placing the metal sheet in the solid state into the mold, further comprising coating a mold releasing agent on the surface of the metal sheet in the solid state.

14. The method of claim 8, wherein, before placing the metal sheet in the solid state into the mold, further comprising coating a protective lubricant on the surface of the metal sheet in the solid state and/or an inner wall of the cavity of the mold.
